(19) United States
(12) Patent Application Publication
(10) Pub. No.: US 2017/0254940 A1
(43) Pub. Date: Sep. 7, 2017

(54) Light Guide Module And Light Guide Structure Thereof

(71) Applicant: GEMTEK TECHNOLOGY CO., LTD., HSINCHU COUNTY (TW)

(72) Inventor: Shih-Ching LEE, HSINCHU COUNTY (TW)

(21) Appl. No.: 15/155,074

(22) Filed: May 16, 2016

(30) Foreign Application Priority Data
Mar. 2, 2016 (CN) 201620157562.1

(51) Int. Cl. F21V 8/00

(52) U.S. Cl. CPC G02B 6/0008

(57) ABSTRACT

A light guide structure includes a light input portion, a light output portion, a plurality of light guide pillars and at least one light-redirecting portion. The light input portion and the light output portion are respectively located on two of the light guide pillars. The light-redirecting portion is connected between adjacent two of the light guide pillars. The roughness, the transmittance or both of them of the light-redirecting portion are different from that of the light guide pillars.

### RELATED APPLICATIONS

This application claims priority to China Application Serial Number 201620157562.1, filed Mar. 2, 2016, which is herein incorporated by reference.

### BACKGROUND

Technical Field

The present disclosure relates to a light guide structure.

Description of Related Art

In recent years, with the increasing development of electronic devices and display devices, a product includes a light-emitting device on the exterior thereof, and this light-emitting device can emit a light related to a status of the product. Such a light-emitting device draws increasing attention in the related field. In general, a light-emitting diode having a small size and high brightness is used as a light source, and a light guide structure is configured to adjust the optical characteristics of the emitted light, such as the brightness, light outgoing angle, to meet various product requirements. However, energy of the light may degrade when the light is redirected by the light guide structure.

### SUMMARY

The disclosure provides a light guide structure, which can reduce the energy attenuation of the light when the light is redirected.

In accordance with some embodiments of the present disclosure, a light guide structure includes a light input portion, a light output portion, a plurality of light guide pillars and at least one light-redirecting portion. The light input portion and the light output portion are respectively located on two of the light guide pillars. The light-redirecting portion is connected between adjacent two of the light guide pillars. The roughness, the transmittance or both of them of the light-redirecting portion are different from that of the light guide pillars.

In accordance with some embodiments of the present disclosure, a light guide module includes the foregoing light guide structures and at least one opaque body slot. The opaque body slot spatially isolates adjacent two of the light guide structures.

In one or more embodiments of this disclosure, since the roughness, the transmittance or both of them of the light-redirecting portion are different from that of the light guide pillars, the difference can assist to effectively redirect the light from one light guide pillar to another light guide pillar, thereby reducing the escaping probability of the light in light-redirecting portion, so that the energy attenuation of the light caused by redirection of the light is reduced, which may benefit to remain a high enough brightness when the light is redirected many times, such as three times, four times or more times.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a light guide module in accordance with some embodiments of the present disclosure.

FIG. 2 is a perspective view of the light guide structure of the light guide module in accordance with some embodiments of the present disclosure.

FIG. 3 is an enlarged schematic view of a light-redirecting portion of the light guide structure in accordance with some embodiments of the present disclosure.

FIG. 4 is an enlarged schematic view of a light-redirecting portion of the light guide structure in accordance with some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

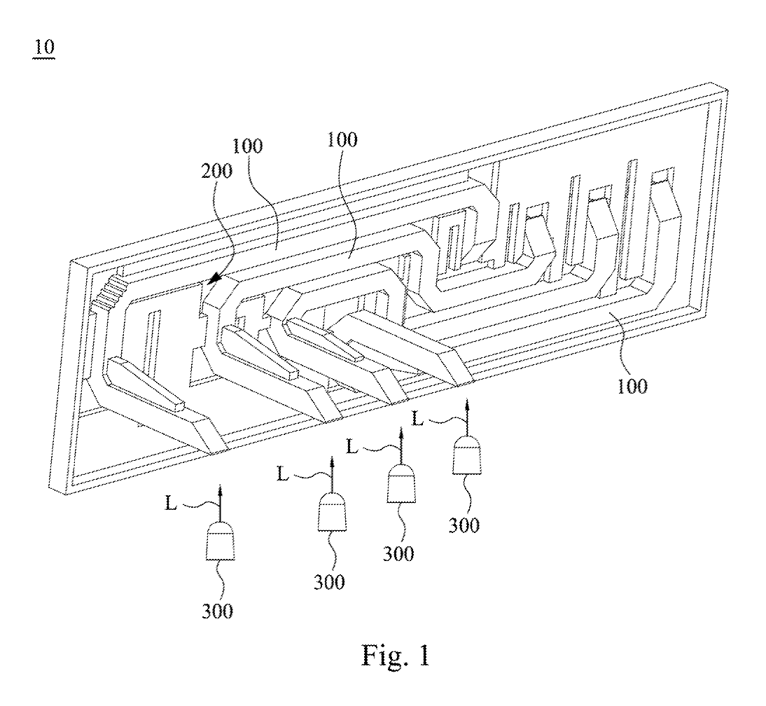

FIG. 1 is a perspective view of a light guide module in accordance with some embodiments of the present disclosure. In FIG. 1, a light guide module 10 includes a plurality of light guide structures 100, at least one opaque body slot 200 and a plurality of light sources 300. In some embodiments, the opaque body slot 200 spatially isolates adjacent two of the light guide structures 100. In other words, the opaque body slot 200 is located between adjacent two of the light guide structures 100. Accordingly, when the opaque body (not shown in this figure) is inserted or went through the opaque body slot 200, the opaque body inserted or going through the opaque body slot 200 can prevent the light of the light guide structure 100 from mutually distributing or interfering, and can also prevent the light of the light guide structure 100 from undesirably scattering. For example, as shown in FIG. 1, in some embodiments, each of the light sources 300 may emit the light L toward the light guide structure 100, and the light guide structure 100 can redirect the received light L to a desired position. Because the opaque body slot 200 is located between adjacent two of the light guide structures 100, the opaque body inserted into the opaque body slot 200 can prevent the light L in one light guide structure 100 from going to another light guide structure 100, thereby avoiding the light in the adjacent light guide structures 100 mutually distributing or interfering.

Particularly, in some embodiments, the adjacent light guide structures 100 have surfaces facing to each other, and the opaque body slot 200 is located between the surfaces that face to each other. In some embodiments, the light guide structure 100 can be completely surrounded by the opaque body slot 200. In some embodiments, the light guide structure 100 can also be partially surrounded by the opaque body slot 200.

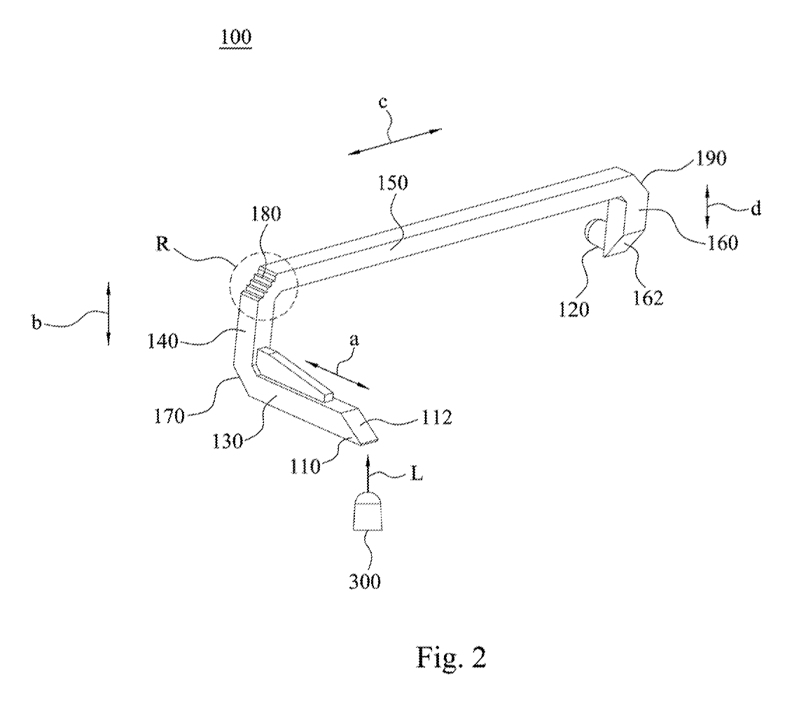

FIG. 2 is a perspective view of the light guide structure 100 and the light source 300 of the light guide module 10 in accordance with some embodiments of the present disclosure. Referring to FIG. 2, the light guide structure 100 includes a light input portion 110, a light output portion 120, a plurality of light guide pillars 130, 140, 150 and 160, and a plurality of light-redirecting portions 170, 180 and 190. The light input portion 110 is located in an irradiation range of the light source 300, and the light input portion 110 may receive the light L emitted by the light source 300. For example, the light source 300 may be a light emitting diode, and the light input portion 110 is located in the irradiation range of the light emitting diode. The light input portion 110 and the light output portion 120 are respectively located on the light guide pillar 130 and the light guide pillar 160. By such a configuration, the light L may go from the light input portion 110 into the light guide pillar 130, and the light L can be guided to the light guide pillar 160 through the light-redirecting portions 170, 180, and 190, and the other light guide pillars 140 and 150, and finally, the light L leaves away the light guide structure 100 from the light output portion 120.

Particularly, the light guide pillar 130 and the light guide pillar 140 are adjacent to each other, and the light-redirecting portion 170 is connected between the light guide pillar 130 and the light guide pillar 140, so the light-redirecting portion 170 can guide the light L from the light guide pillar 130 into the light guide pillar 140. Similarly, the light guide pillar 140 and the light guide pillar 150 are adjacent to each other, and the light-redirecting portion 180 is connected between the light guide pillar 140 and the light guide pillar 150, so the light-redirecting portion 180 can guide the light L from the light guide pillar 140 into the light guide pillar 150. Similarly, the light guide pillar 150 and the light guide pillar 160 are adjacent to each other, and the light-redirecting portion 190 is connected between the light guide pillar 150 and the light guide pillar 160, so the light-redirecting portion 190 can guide the light L from the light guide pillar 150 into the light guide pillar 160.

The roughness, the transmittance or both of them of at least one light-redirecting portion shown in FIG. 2 are different from that of the light guide pillars connected and adjacent to the light-redirecting portion. Such a difference can assist to redirect the light L and benefit to transmit the light L in the light guide structure 100, thereby reducing the energy attenuation of the light L when the light L is redirected, so as to remain a high enough brightness after the light L is guided by the light guide structure 100. For example, take the light-redirecting portion 180 as instance, the roughness of the light-redirecting portion 180 may be different from the roughness of the light guide pillars 140 and 150. More particularly, the roughness of the light-redirecting portion 180 may be greater than the roughness of the light guide pillars 140 and 150. Accordingly, when the light L goes from the light guide pillar 140 into the light-redirecting portion 180 and arrives at the rough surface of the light-redirecting portion 180, the optical effect caused by the rough surface of the light-redirecting portion 180 can assist to redirect the light L to the light guide pillar 150, thereby reducing the energy attenuation of the light L when the light L is redirected by light-redirecting portion 180, which may benefit to maintain the brightness after the light L is redirected.

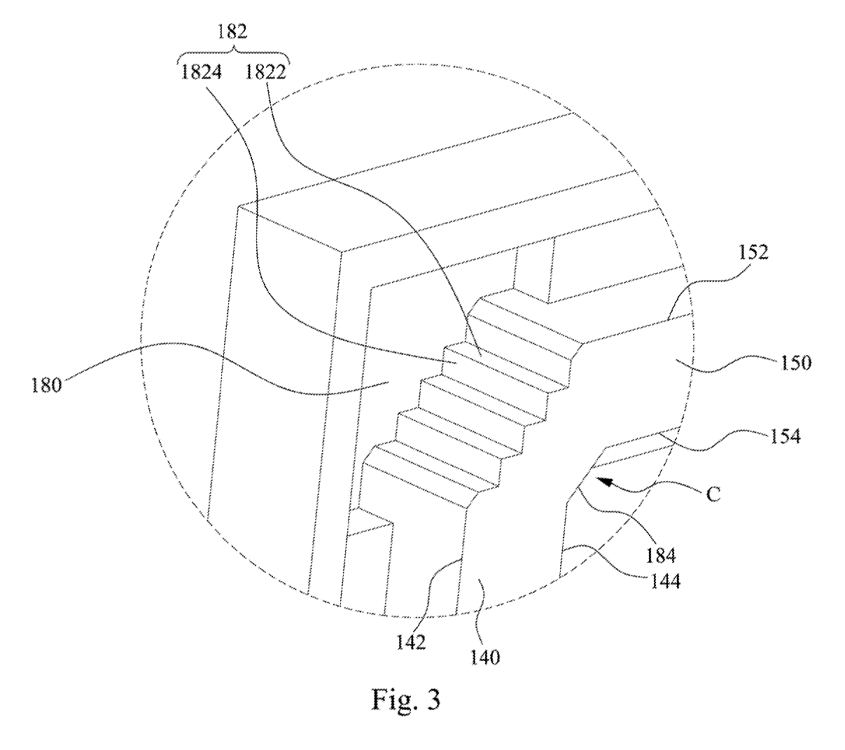

More particularly, reference is made to FIG. 3, which is an enlarged schematic view of the local area R in FIG. 2. As shown in FIG. 3, the light-redirecting portion 180 has an outer surface 182. The outer surface 182 is distal to a corner C formed by the adjacent light guide pillars 140 and 150. The outer surface 182 is a undulating surface, so it is beneficial to reduce the energy attenuation of the light L when the light L is redirected by the light-redirecting portion 180. In particular, the light guide pillar 140 has an outer surface 142 and an inner surface 144 opposite to each other. The light guide pillar 150 has an outer surface 152 and an inner surface 154 opposite to each other. The light-redirecting portion 180 has an inner surface 184 opposite to the outer surface 182. The inner surface 184 is connected between the inner surface 144 and the inner surface 154, and the corner C is defined by the inner surface 184, the inner surface 144 and the inner surface 154. In other words, the corner C is located beside the inner surfaces 144, 154 and 184. The outer surface 182 is connected between the outer surfaces 142 and 152, and it is distal to the corner C. The outer surface 182 is a undulating surface, and the outer surface 142 and the outer surface 152 are flat surfaces. In other words, the outer surface 182 of the light-redirecting portion 180 is rougher than the outer surface 142 of the light guide pillar 140 and the outer surface 152 of the light guide pillar 150. When the light arrives at the outer surface 182 of the light-redirecting portion 180, the undulating design of the outer surface 182 can assist to redirect the light to the light guide pillar 150, so it can reduce the energy attenuation of the light L when the light L is redirected, thereby benefiting to maintain the brightness after the light L is redirected.

Particularly, as shown in FIG. 3, the outer surface 182 of the light-redirecting portion 180 includes a plurality of first sub-surfaces 1822 and a plurality of second sub-surfaces 1824. The first sub-surfaces 1822 and the second sub-surfaces 1824 are arranged in an alternating manner, and the first sub-surfaces 1822 are non-parallel with the second sub-surfaces 1824. By the design of the non-parallel and alternating arrangement of the first sub-surfaces 1822 and the second sub-surfaces 1824, the outer surface 182 can be undulating and hence it increases the roughness of the light-redirecting portion 180, thereby reducing the energy attenuation of the light when the light is redirected.

In some embodiments, as shown in FIG. 3, the first sub-surfaces 1822 are substantially perpendicular to the second sub-surfaces 1824. In other words, the outer surface 182 of the light-redirecting portion 180 is formed in a staircase shape. The first sub-surfaces 1822 and second sub-surfaces 1824 substantially perpendicular to each other can effectively reduce the energy attenuation of the light when the light is redirected. In some embodiments, the first sub-surfaces 1822 are substantially parallel to the outer surface 152 of the light guide pillar 150, and the second sub-surfaces 1824 are substantially parallel to the outer surface 142 of the light guide pillar 140, and hence it may benefit to reduce the energy attenuation of the light when the light is redirected.

In some embodiments, at least one of the first sub-surface 1822 and the second sub-surface 1824 is a matte surface. In other words, in some embodiments, the first sub-surface 1822 is the matte surface, and the second sub-surface 1824 is not the matte surface. In some embodiments, the second sub-surface 1824 is the matte surface, and first sub-surface 1822 is not the matte surface. In some embodiments, the first sub-surface 1822 and the second sub-surface 1824 are all the matte surfaces. The design of the matte surface may increase the roughness of the light-redirecting portion 180 and hence reduce the energy attenuation of the light when the light is redirected. In some embodiments, the matte surface may be formed by the mechanical treatment or the chemical treatment, such as a texturing process, a brush discharge process, a chemical etching process, an electroforming process or the like. In particular, the above processes can make the surface include convex or concave microstructures, thereby forming the matte surface.

In some embodiments, the outer surface 182 of the light-redirecting portion 180 does not include the first sub-surfaces 1822 and the second sub-surfaces 1824 arranged in the alternating manner. Instead, the whole outer surface 182 is a matte surface. Such a matte surface design may increase the roughness of the light-redirecting portion 180 and hence reduce the energy attenuation of the light when the light is redirected. In some embodiments, the matte surface may be formed by the mechanical treatment or the chemical treatment, such as a texturing process, a brush discharge process, a chemical etching process, an electroforming process or the like. In particular, the above processes can make the surface include convex and concave microstructures, thereby forming the matte surface.

It is understood that the above embodiments take the light-redirecting portion 180 as example, but in other embodiments, the light-redirecting portions 170, 180, 190 or any combination thereof can have designs the same as the light-redirecting portion 180 shown in FIG. 3 and described in the foregoing context. In other words, in some embodiments, the roughness, the transmittance or both of them of the light-redirecting portion 170 are different from that of the light guide pillars 130 and 140. In some embodiments, the roughness, the transmittance or both of them of the light-redirecting portion 190 are different from that of the light guide pillars 150 and 160. By such a configuration, the light-redirecting portions 170, 180 or 190 can all reduce the energy attenuation of the light L when the light L is redirected.

In some embodiments, the light input portion 110 has a redirecting surface 112. The redirecting surface 112 is located within the irradiation range of the light source 300, and the redirecting surface 112 is not parallel and not perpendicular to the optical axis of the light source 300 (such as an imaginary axis overlapping with the light L shown in FIG. 2), so it can guide the light L from the light source 300 to the light guide pillar 130. In some embodiments, the redirecting surface 112 is also a rough surface to reduce the energy attenuation of the light L when the light L is redirected.

In some embodiments, the light guide pillar 160 has a redirecting surface 162. The redirecting surface 162 faces to a corner formed by the light guide pillar 160 and light output portion 120, and it can guide the light L from the light guide pillar 160 to the light output portion 120. In some embodiments, the redirecting surface 162 is also a rough surface to reduce the energy attenuation of the light L when the light is redirected.

In accordance with some embodiments of the present disclosure, because the light-redirecting portions 170, 180 and 190 can effectively assist to redirect the light and can reduce the energy attenuation of the light L when the light is redirected, the brightness of the light L can be remained on a certain level when the light L is redirected many times. For example, the brightness of light L can be maintained on a certain level after the light L is redirected by the light-redirecting portions 170, 180 and 190 and transmitted by the light guide pillars 140, 150 and 160. Therefore, the light input portion 110 and the light output portion 120 can be respectively located on the light guide pillars 130 and 160. That is, the light input portion 110 and the light output portion 120 are located on two light guide pillars that are spatially separated from each other. More particularly, the light input portion 110 and the light output portion 120 are located on two of the light guide pillars that are farthest away from each other.

Referring to FIG. 2, in some embodiments, light guide pillars 130, 140, 150 and 160 adjacent to each other have lengthwise directions intersecting each other. Because the lengthwise directions of adjacent two of light guide pillars 130, 140, 150 and 160 are non-parallel and intersecting, the light L can be redirected by the light-redirecting portions 170, 180 and 190 and transmitted in the light guide structure 100. For example, in some embodiments, because the lengthwise directions of the light guide pillars 130 and 140 are non-parallel and intersecting, the light L in the light guide pillar 130 after being redirected by the light-redirecting portion 170 can go into the light guide pillar 140. Similarly, because the lengthwise directions of the light guide pillars 140 and 150 are non-parallel and intersecting, the light L in the light guide pillar 140 after being redirected by the light-redirecting portion 180 can go into the light guide pillar 150. Similarly, because the lengthwise directions of the light guide pillars 150 and 160 are non-parallel and intersecting, the light L in the light guide pillar 150 after being redirected by the light-redirecting portion 190 can go into the light guide pillar 160. Thereafter, the light L can leave away from the light guide structure 100 by the light output portion 120.

Particularly, in some embodiments, as shown in FIG. 2, the light input portion 110 is located on an end of the light guide pillar 130, and the light guide pillar 140 is located on another end of the light guide pillar 130 which is distal to the light input portion 110. A lengthwise direction b of the light guide pillar 140 intersects a lengthwise direction a of the light guide pillar 130 where the light input portion 110 is located. The light guide pillar 150 is located on an end of the light guide pillar 140, and the end is distal to the light guide pillar 130. A lengthwise direction c of the light guide pillar 150 intersects the lengthwise direction b of the light guide pillar 140. The light guide pillar 160 is located on an end of the light guide pillar 150, and the end is distal to the light guide pillar 140. A lengthwise direction d of the light guide pillar 160 intersects the lengthwise direction c of the light guide pillar 150. As a result, the light L emitted by the light source 300 can be received through the light input portion 110 on the light guide pillar 130 and then can sequentially be transmitted to the light guide pillar 130, the light-redirecting portion 170, the light guide pillar 140, the light-redirecting portion 180, the light guide pillar 150, the light-redirecting potion 190, the light guide pillar 160 and the light output portion 120 on the light guide pillar 160, and the light L can be guided out of the light guide structure 100. In some embodiments, the light L transmitted through the light guide structure 100 can be outputted from any position by adjusting the length of the light guide pillars 130, 140, 150 or 160 or by adjusting the lengthwise direction of the light guide pillars 130, 140, 150 or 160. Referring to FIG. 2, in some embodiments, the length of the light guide pillar 150 can be shortened or lengthened, thereby correspondingly change the locations of the light-redirecting portion 190, light guide pillar 160 and light output portion 120, so it can change the light output position of the light guide structure 100. Alternatively, in some embodiments, the light guide pillar 160 can protrude from the light guide pillar 150 upwardly, and it is not limited to protrude downwardly as shown in the figures, thereby change the position of the light output portion 120, so the light output position of the light guide structure 100 can be changed.

Referring to FIG. 2, in some embodiments, the lengthwise direction a of the light guide pillar 130 and the lengthwise direction b of the light guide pillar 140 are perpendicular to each other, and the light-redirecting portion 170 is connected between the light guide pillars 130 and 140, so as to guide the light L from the light guide pillar 130 into the light guide pillar 140. In other words, by the light-redirecting portion 170 that connects the light guide pillars 130 and 140 having lengthwise directions perpendicular to each other, the light L transmitted in the light guide pillar 130 can be redirected almost perpendicularly (about 90°) and then the light L can be transmitted in the light guide pillar 140. In other words, the lengthwise direction a of the light guide pillar 130 and the lengthwise direction b of the light guide pillar 140 are substantially perpendicular to each other. In some embodiments, the lengthwise direction b of the light guide pillar 140 and the lengthwise direction c of the light guide pillar 150 are substantially perpendicular to each other, so that the light L transmitted in the light guide pillar 140 can be redirected almost perpendicularly (about 90°) and then the light L can be transmitted in the light guide pillar 150. In some embodiments, the lengthwise direction c of the light guide pillar 150 and the lengthwise direction d of the light guide pillar 160 are substantially perpendicular to each other, so that the light L transmitted in the light guide pillar 150 can be redirected almost perpendicularly (about 90°) and then the light L can be transmitted in the light guide pillar 160. By such a configuration, the light L can be redirected many times in the light guide structure 100.

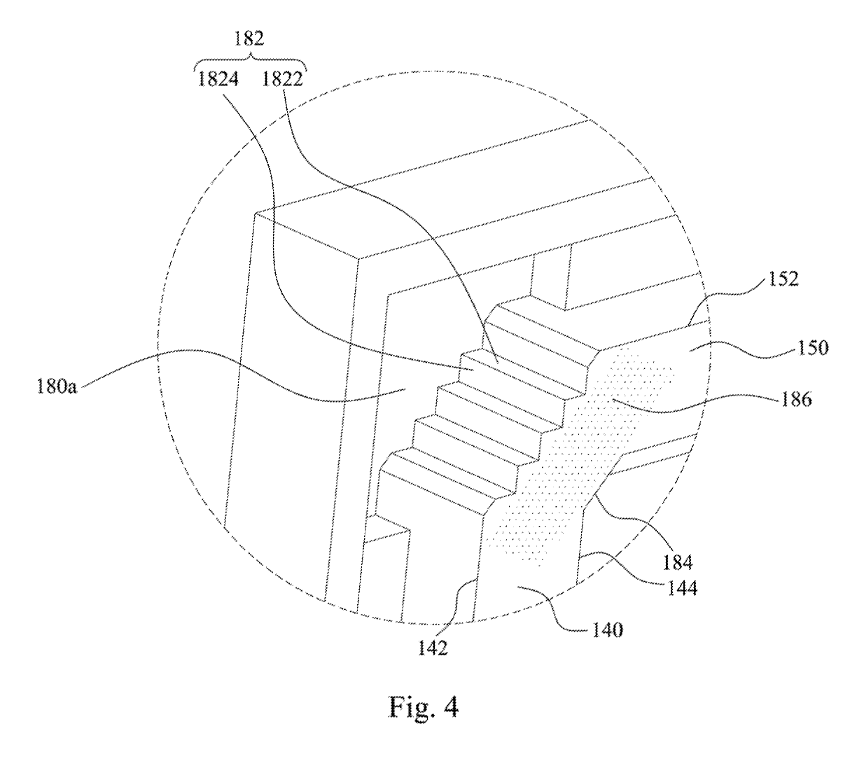

FIG. 4 is an enlarged schematic view of a light-redirecting portion of the light guide structure in accordance with some embodiments of the present disclosure. As shown in FIG. 4, the main difference between this embodiment and the foregoing embodiment is that: the light-redirecting portion 180a of the light guide structure 100 includes a plurality of reflective powdery structures 186 therein. The reflective powdery structures 186 are formed by adding additives in the light-redirecting portion 180a. The reflective powdery structures 186 may be circular, elliptical or any shaped microstructures to scatter the light and improve the scattering effect of the light, and hence reduce the energy attenuation of light when the light is redirected. In some embodiments, ratio of the reflective powdery structures 186 to the light-redirecting portion 180a can be varied by adjusting the amount of the additives, and hence the transmittance of the light-redirecting portion 180a can be adjusted, so that the transmittance of the light-redirecting portion 180a and the transmittances of the adjacent light guide pillars 140 and 150 can be different. Therefore, the brightness of the light output portion 120 of the light guide structure 100 can be adjusted. In some embodiments, the outer surface 182 of the light-redirecting portion 180a may be a rough surface (such as a staircase shape shown in FIG. 4). In other embodiments, the roughness of the outer surface 182 of the light-redirecting portion 180a can be substantially the same as that of the outer surface 142 of the light guide pillar 140 and the outer surface 152 of the light guide pillar 150. In other words, when the light-redirecting portion 180a has the reflective powdery structures 186, the outer surface 182 may be a flat surface.

It is understood that the above embodiments take the light-redirecting portion 180a as example, but in other embodiments, the light-redirecting portion 170 and 190 or both of them can have the design the same as the light-redirecting portion 180a. In other words, in some embodiments, the light-redirecting portion 170 may have the reflective powdery structures 186 to reduce the energy attenuation in the light-redirecting portion 170. In some embodiments, the light-redirecting portion 190 may have the reflective powdery structures 186 to reduce the energy attenuation in the light-redirecting portion 190. In some embodiments, the light input portion 110 may have the reflective powdery structures 186 to reduce the energy attenuation in the light input portion 110. Moreover, in some embodiments, the end of the light guide pillar 160 which is proximal to the light output portion 120 may also have the reflective powdery structures 186 to reduce the energy attenuation when the light is redirected to the light output portion 120.

In accordance with some embodiments of the present disclosure, since the roughness, the transmittance or both of them of the light-redirecting portion are different from that of the light guide pillars, the energy attenuation of the light caused by redirection of the light can effectively be reduced, which may benefit to remain a high enough brightness when the light is redirected many times, such as three times, four times or more times. In addition, since the light can be redirected many times, it is beneficial to change the light output position of the light guide structure, so as to guide the light to any position of the exterior of the product.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light guide structure, comprising:
a light input portion;
a light output portion;
a plurality of light guide pillars, the light input portion and the light output portion being respectively located on two of the light guide pillars; and
at least one light-redirecting portion connected between adjacent two of the light guide pillars, wherein the roughness, the transmittance or both of them of the light-redirecting portion are different from that of the light guide pillars.

2. The light guide structure of claim 1, wherein the light guide pillars connected by the light-redirecting portion have substantially perpendicular lengthwise directions.

3. The light guide structure of claim 1, wherein any two of the light guide pillars adjacent to each other have lengthwise directions intersecting each other, and wherein the light input portion and the light output portion are located on two of the light guide pillars that are spatially separated from each other.

4. The light guide structure of claim 1, wherein at least one of the light guide pillars is connected to the light guide pillar where the light input portion is located, and wherein the at least one of the light guide pillars has a lengthwise direction intersecting that of the light guide pillar where the light input portion is located.

5. The light guide structure of claim 1, wherein the light-redirecting portion has an outer surface, the outer surface is distal to a corner formed by the adjacent two of the light guide pillars, and the outer surface is undulating.

6. The light guide structure of claim 5, wherein the outer surface of the light-redirecting portion comprises:
a plurality of first sub-surfaces; and
a plurality of second sub-surfaces, wherein the first sub-surfaces and the second sub-surfaces are arranged in an alternating manner, and the first sub-surfaces are non-parallel with the second sub-surfaces.

7. The light guide structure of claim 6, wherein the first sub-surfaces are substantially perpendicular to the second sub-surfaces.

8. The light guide structure of claim 6, wherein at least one of the first sub-surfaces and the second sub-surfaces is a matte surface.

9. The light guide structure of claim 5, wherein the outer surface of the light-redirecting portion is a matte surface.

10. The light guide structure of claim 1, wherein the light-redirecting portion comprises a plurality of reflective powdery structures therein.

11. A light guide module, including:
a plurality of light guide structures, each of the light guide structures comprising:
a light input portion;
a light output portion;
a plurality of light guide pillars, the light input portion and the light output portion being respectively located on two of the light guide pillars; and
at least one light-redirecting portion connected between adjacent two of the light guide pillars, wherein the roughness, the transmittance or both of them of the light-redirecting portion are different from that of the light guide pillars; and
at least one opaque body slot spatially isolating adjacent two of the light guide structures.

12. The light guide module of claim 11, wherein the light guide pillars connected by the light-redirecting portion have substantially perpendicular lengthwise directions.

13. The light guide module of claim 11, wherein any two of the light guide pillars adjacent to each other have lengthwise directions intersecting each other, and wherein the light input portion and the light output portion are located on two of the light guide pillars that are spatially separated from each other.

14. The light guide module of claim 11, wherein at least one of the light guide pillars is connected to the light guide pillar where the light input portion is located, and wherein the at least one of the light guide pillars has a lengthwise direction intersecting that of the light guide pillar where the light input portion is located.

15. The light guide module of claim 11, wherein the light-redirecting portion has an outer surface, the outer surface is distal to a corner formed by the adjacent two of the light guide pillars, and the outer surface is undulating.

16. The light guide module of claim 15, wherein the outer surface of the light-redirecting portion comprises:
a plurality of first sub-surfaces; and
a plurality of second sub-surfaces, wherein the first sub-surfaces and the second sub-surfaces are arranged in an alternating manner, and the first sub-surfaces are non-parallel with the second sub-surfaces.

17. The light guide module of claim 16, wherein the first sub-surfaces are substantially perpendicular to the second sub-surfaces.

18. The light guide module of claim 16, wherein at least one of the first sub-surfaces and the second sub-surfaces is a matte surface.

19. The light guide module of claim 15, wherein the outer surface of the light-redirecting portion is a matte surface.

20. The light guide module of claim 11, wherein the light-redirecting portion comprises a plurality of reflective powdery structures therein.
